(19) United States
(12) Patent Application Publication
(10) Pub. No.: US 2014/0074733 A1
(43) Pub. Date: Mar. 13, 2014

(54) PHOTOGRAPH INITIATED APPRAISAL PROCESS AND APPLICATION

(71) Applicants: Nathan Pieter Den Herder, Falls Church, VA (US); John Brevard Sigman, McLean, VA (US); Nathan Lande, Arlington, VA (US); Eric Rosenblatt, Derwood, MD (US)

(72) Inventors: Nathan Pieter Den Herder, Falls Church, VA (US); John Brevard Sigman, McLean, VA (US); Nathan Lande, Arlington, VA (US); Eric Rosenblatt, Derwood, MD (US)

(73) Assignee: Fannie Mae, Washington, DC (US)

(21) Appl. No.: 13/614,705

(22) Filed: Sep. 13, 2012

(51) Int. Cl. G06Q 99/00

(52) U.S. Cl. 705/306

(57) ABSTRACT

The present invention relates to photograph initiated property assessment. In one example, an electronic device performs a photograph initiated property assessment by accessing a photographic assessment itinerary that includes a plurality of target portions for the subject property and a set of image capture requirements for each of the plurality of target portions. Further, when performing the initiated property assessment the electronic device prompts a plurality of image capture requests according to the photographic assessment itinerary while displaying a menu that permits the addition of information to the set of image captures.

### BACKGROUND OF THE INVENTION

1. Field of the Invention

This application relates generally to a photograph initiated appraisal process and application for evaluating a subject property and, more particularly, to photograph initiated appraisal process for data assembly, past appraisal and value comparison, comparable property finder, and property evaluation.

2. Description of the Related Art

Property valuation and data gathering methods have been developed to estimate property values. A typical valuation and data gathering method is a home inspection in which a home inspector performs a review of a subject property by surveying the rooms and fixtures of the subject property and estimating the subject property's value based upon the review. The review itself commonly consists of written notes that the home inspector records. Yet, these notes may not be especially useful for when the data is incomplete, inaccurate, or saturated with subjectivity. For example, a home inspector may mistakenly record the features of a kitchen, such as recording an unfinished wood floor when the kitchen floor is clearly stone tile. If a picture of the kitchen was associated with an appraisal report, an evaluator of the appraisal could easily see the entry mistake without physically visiting the property. Currently, there is no such procedure for associating pictures with a home evaluation.

Thus, there is a need for a sophisticated regimented procedure of implementing a home inspection in accordance with photographs that may be evaluated at a later time without the evaluator's physical presence at a subject property.

### SUMMARY OF THE INVENTION

The present invention relates to photograph initiated property assessment. In one example, an electronic device performs a photograph initiated property assessment by accessing a photographic assessment itinerary that includes a plurality of target portions for the subject property and a set of image capture requirements for each of the plurality of target portions. Further, when performing the initiated property assessment the electronic device prompts a plurality of image capture requests according to the photographic assessment itinerary while displaying a menu that permits the addition of information to the set of image captures.

The described may be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the described are more fully disclosed in the following specification, reference being had to the accompanying drawings, in which:

FIG. 1 is a flow diagram illustrating an example of a photograph initiated property assessment process;

FIGS. 2A-B are block diagrams illustrating examples of a photograph initiated property assessment application;

FIGS. 3A-B are block diagrams illustrating examples of a system in which a photograph initiated property assessment application operates; and

FIG. 4 is a flow diagram illustrating another example of a photograph initiated property assessment process.

### DETAILED DESCRIPTION OF THE INVENTION

In the following description, for purposes of explanation, numerous details are set forth, such as flowcharts and system configurations, to provide an understanding of one or more embodiments. However, it is and will be apparent to one skilled in the art that these specific details are not required to practice the described invention.

The present invention provides an application for a tablet, a smartphone, a laptop, or a similar device that utilizes imaging technology and numerous data sources to provide an assessment of a subject property.

More particularly, the present invention relates to photograph initiated appraisal application, where instructions (e.g. a photographic assessment itinerary) are provided to a user for acquiring pictures of a subject property including subroutines for defining characteristics relating to each picture during or after picture acquisition.

For instance, when using an tablet with the photograph initiated appraisal application installed thereon, the application instructs a user to sequentially take photographs with a built-in tablet camera of the rooms of a subject property while tagging the photos with information (e.g. if there are granite counter in the kitchen, whether the fireplace is wood, gas, or electric, and so forth). The photographs and related descriptions may then be used by an appraiser for subject property evaluation in connection with market information relating to the subject property. In addition, the application may also use the tablet's location technology to apply location tags to photographs that the user may directly identify or confirm. Further, using a heuristic construct, the application may more accurately discern a subject property's location as the amount of distinct location tags associated with user confirmations increases.

The photograph initiated appraisal application may also be integrated with a uniform residential appraisal report (appraisal form), which is a form that provides information about a subject property, such as, square footage, number of units, year built, appliances, foundation, exterior description, etc. Through this integration, the application is capable of extracting information from the appraisal form and enhance the extracted information by crosschecking the information with an executed photographic assessment itinerary and by gleaning information from MLS listings, GIS data, or other statements about the subject property.

The application may also trigger a search based on the location determination technology to find comparable properties that are similar across home characteristics identified by the executed photographic assessment itinerary. Such characteristics include number of bedrooms, type of flooring in each bedroom, view from bedroom windows, number of bathrooms, type of fixtures in each bathrooms, neighborhood, etc. The application may also provide value and appraisal history for the subject property based on collected past value and valuation data and provide valuation using said comparable properties in a regression model. Further, the application may also generate or retrieve a local pricing index to provide a benchmark for over or under valuations. Thus, the application utilizes imaging and location determination technology in connection with an appraisal form to accurately account for features of a subject property in the subject property evaluation.

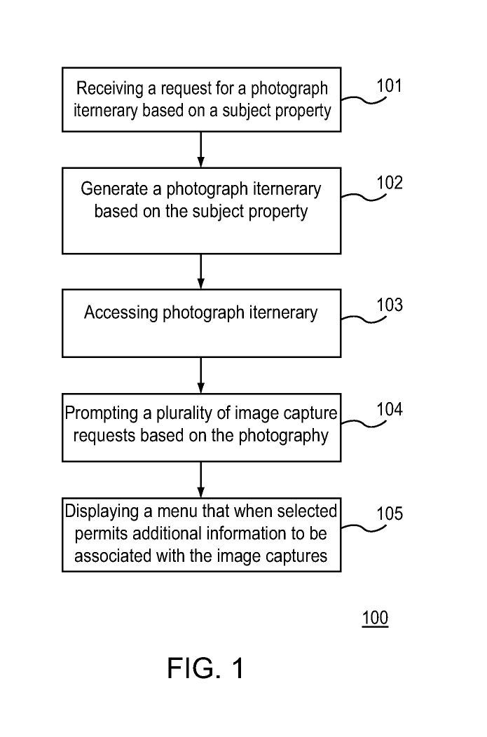

FIG. 1 is a flow diagram illustrating an example of a photograph initiated property assessment process 100. The photograph initiated property assessment process 100 begins after receiving 101 a request for a photographic assessment itinerary for a subject property. A property type and a property location of subject property may be associated with the request for a photographic assessment itinerary.

For example, when the request is generated, the property address based on a location determination technology and address tables may be automatically attached to the request. Further, the property type may be automatically extracted from the property address. For example, when an address is located on a street comprising of townhomes, the process 100 may assign a townhome property type designation for the subject property. Then using the townhome property type, a photographic assessment itinerary relative to a townhome is generated 102 in response to the request.

Once generated, the process 100 continues by accessing 103 the photographic assessment itinerary, which includes a plurality of target portions for the subject property and a set of image capture requirements for each of the plurality of target portions, and prompting 104 a plurality of image capture requests according to the photographic assessment itinerary. While prompting 104 the plurality of image capture requests, the process in synchronization or association with the requests displays 105 a menu that allows additional information to be associated with captured images.

A preferred way of implementing the photograph initiated property assessment process 100 is by using a tablet computer, with a photograph initiated property assessment application installed thereon. However, the tablet computer is not the only contemplated computer system. Any computer system, such as a laptop computer, a handheld portable computer, or a desktop computer (e.g., tablets, PDAs, cell phones, mobile phones, smart-phones, super-phones, and the like), may be used. The computer system runs any conventional operating system through the interaction of the processor (a central or graphics processing unit) and a memory to carry out the described operability by execution of computer instructions. Operating systems may include but are not limited to iOS, Android, Windows, UNIX, Linux, Macintosh, or the like. The computer system may further implement applications that facilitate calculations, such as the heuristic mathematical construct described below.

The memory may be any memory suitable for storing data, such as any volatile or non-volatile memory, whether virtual or permanent, or any other non-transitory computer readable medium (e.g., compact disk, hard disk, and the like). Preferably, the memory stores the photograph initiated property assessment application, which comprises program code that is executable by the processor to perform operations in support of subject evaluation. In addition, the memory may also store predetermined photographic assessment itineraries, target sets associated with different property type, market data for comparative evaluations, or any data used to support a photograph initiated property assessment. Further, the operations described herein may be implemented on any conventional network (e.g., cellular network, global area network, wireless local area networks, wide area networks, local area networks, or combinations thereof, but is not limited thereto) that will be readily apparent to the artisan and need not be named herein.

Therefore, the photograph initiated property assessment application is preferably provided as software on the computer system described above, yet it may alternatively be hardware, firmware, or any combination of software, hardware, and firmware. Still other embodiments include computer implemented processes described in connection with the figures. Further, an artisan will readily recognize the various alternative programming languages and execution platforms that are and will become available, and the described is not limited to any specific execution environment. Thus according to one aspect, the photograph initiated property assessment process 100 is implemented in an application that comprises program code stored on a non-transitory computer readable medium executable to perform operations of the photograph initiated property assessment process 100.

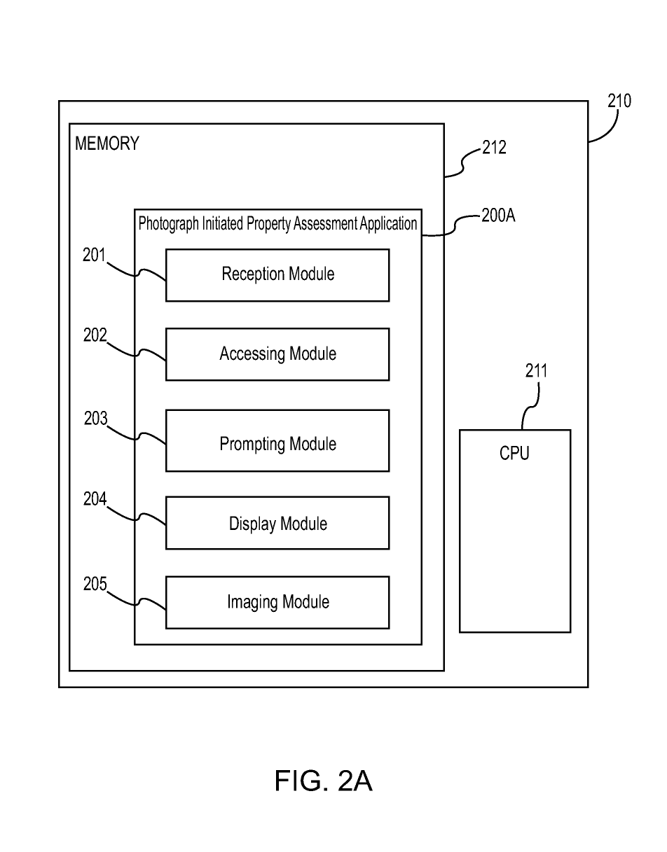

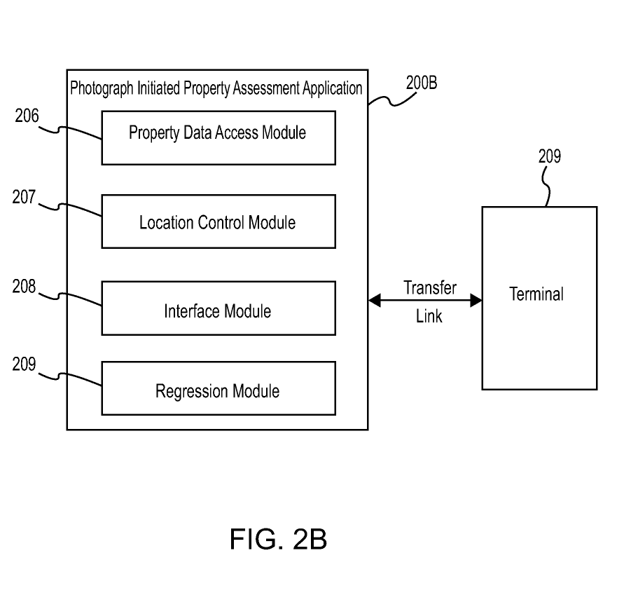

FIGS. 2A-B are block diagrams illustrating examples of a photograph initiated property assessment application. Specifically, FIG. 2A is a block diagram illustrating an example of an electronic device 210 that comprises a photograph initiated property assessment application 200A stored on a memory 212 and constructed from program code that is executable by a central processing unit (CPU) 211 to perform operations of a photograph initiated property assessment process 100. Alternatively, the electronic device 210 may be any of the computer systems described above, and further the photograph initiated property assessment application 200A may be implemented in any of the conventional networks described above or represented below.

The application 200A is configured to provide a photograph initiated property assessment by generating a photographic assessment itinerary that is used for subject property evaluation. The example of the application 200A of FIG. 2A includes a reception module 201, an accessing module 202, a prompting module 203, a display module 204, and an imaging module 205. Although one modular breakdown of the application 200A is offered, it should be understood that the same operability may be provided using fewer, greater, or differently named modules.

In FIG. 2A, the reception module 201 includes program code for receiving a request for a photographic assessment itinerary for a subject property. Further, the reception module 202 may in response to the request generate the photographic assessment itinerary for a subject property or forward the request to an external device (not shown) so that the photographic assessment itinerary may be generated by the external device and returned to the electronic device 210. Furthermore, the reception module 201 includes program code for receiving and processing property type and location information that may be associated with the request for the photographic assessment itinerary.

The accessing module 202 includes program code for storing and accessing a photographic assessment itinerary for a subject property. That is, once generated or received, the accessing module 202 stores the photographic assessment itinerary, which includes a plurality of target portions for the subject property and a set of image capture requirements for each of the plurality of target portions, and access portions of the photographic assessment itinerary for processing.

The prompting module 203 includes program code for generating, assigning, and prompting a plurality of image capture requests according to the photographic assessment itinerary. While prompting the plurality of image capture requests, the prompting module 203 may also prompt menus for submitting additional information along with the image capture.

For example, the prompting module 203 may provide single click interface to facilitate a user's immediate interaction with the electronic device 210. In particular, the prompting module 203 provides the single click interface that is displayed by the display module 204 and works in conjunction with the imaging module 205 to instruct the user to capture a portion of the subject property relative to the currently accessed portion of the photographic assessment itinerary. Similarly, for example, the prompting module 203 may provide a single click interface to initiate a detection of a physical location of the electronic device 210. Further, the prompting module 203 may suggest through assorted menus descriptions for the captured images and multiple addresses for the current physical location of the electronic device 210. Based on the user selection, further prompts that the appropriate tools may be generated by the prompting module 203.

The display module 204 includes program code for assisting in the execution of the functions of the accessing module 202, the prompting module 203, and the imaging module 205. That is, the display module 204 includes program code for managing the display and receipt of information from a user to provide the described operability of the accessing module 202 and the prompting module 203 and permits user management of the results of the application 200A. The display module 204 permits the application 200A, any acquired photographs, the photographic assessment itinerary, and the like to be displayed on a display device in a map, menu, icon, tabular, or grid format, with various functional representations according to the application's 200A required operability. In addition, the display module 204 provides mapping and analytical tools to the user that implement the photograph initiated property assessment application's features, such as concurrently displaying a table or grid of data with the photographic assessment itinerary so that a user can readily obtain the results of the photograph initiated property assessment. Further, the table view allows the user to sort the list of photographs based on of defined property characteristics, rankings, or any other dimensions. The rows in the table may be connected to a photograph or appraisal database through the property data access module 206 described below, as well as the related additional market resources 320 defined below. Combined with the map view, this allows for a convenient yet comprehensive interactive analysis of a subject property.

Additionally, the display module 204 may include program code for accessing mapping functions for displaying photographs corresponding to the relative surrounding geographical area of the electronic device 210 based on the current physical location and managing the depiction of the map images indicative of the subject property and at least one comparable property. Further, the display module 204 may display on the display device the subject property and corresponding properties within a defined geographic area with demarcations of the defined geographic area (i.e., highlighted boundaries) as the neighborhood of interest. The neighborhood may be defined by inclusion within a user-defined shape, exclusion of a user-defined shape from a previously defined geographic area, the set of properties within a given distance from a subject property, properties corresponding to a tract or adjacent tracts, or properties currently displayed on a map image (which may be manipulated as desired, prior to user indication to lock in the defined area).

The imaging module 205 includes program code for operating the imaging system of the electronic device in accordance with the photographic assessment itinerary and user interactions or for interacting with an imaging system that is either directly or remotely attached to the electronic device 210.

FIG. 2B is a block diagram illustrating an example of a photograph initiated property assessment application 200B that is external to a terminal 209, which accesses the operability of the photograph initiated property assessment application 200B. That is, a user device or a tablet may act as a terminal 209 where through either web browsing or mobile application technology the application 200B is configured to run in the context of a server or host. Further, the application 200B at least includes a property data access module 206, a location control module 207, an interface module 208, and a regression module 209. Furthermore, the application 200B may include any of the other modules listed in FIG. 2A. Again, it should be understood that the same operability may be provided using fewer, greater, or differently named modules and it should be understood that the operability of those modules may over lap, integrate, and be located on the same or separate devices.

In FIG. 2B, the property data access module 206 includes program code for carrying out access to and management of property data, whether from resources internal or external to the electronic device 210, and corresponding photographic appraisal information. Further, the property data access module 206 works with the display module 204 and the regression module 209 to acquire comparable properties and with the display module 204 to display on a display device the property data and corresponding photographic appraisal information. The property data access module 206 includes program code for creating, manipulating, associating, and processing appraisal forms that provide information about a subject property; producing the property data for the application 200A; and retrieving/supplying appraisal forms for a subject property, which may be retrieved based upon a variety of criteria, including searches by subject property, identification number, or property characteristics (appraiser ID, vendor, date, photographic descriptions, etc.).

The location control module 207 includes program code for operating the location technology of the electronic device. That is, when a location determination is requested, the location control module 207 operates to correlate a physical location of an electronic device with addressed information by using conventional mapping algorithms and mapping databases. The location control module 207 determines the physical location using any location determination technology, such as time of flight (measuring distance by the time of propagation of pulsed signals, e.g. global positioning systems), spatial scan (triangulating using a beacon and sensor), inertial sensing (measuring position with an accelerometer), phase difference (measuring the shift in phase for incoming signals), or a hybrid thereof. Some of these technologies may be referred to as network-based, handset-based, or SIM-based technologies. Regardless of the colloquial term, any of the numerous location determination technologies that would be readily apparent to an artisan may be employed by the location control module 207. Further, it is preferred that the location determination technology is activated upon request. Alternatively, the location based technology may continuously run for a predetermined idle time, and only after a pre-determined idle time may the location based technology deactivate to conserve battery life.

The interface module 208 is configured to communicate directly with other applications, modules, models, devices, and other sources through both physical and virtual interfaces. The interface module 208 manages the dispatching and receipt of information in relation to the above sources and sources external to the application along with integrating the application 200A with other applications and drivers, as needed per operating system.

The regression module 209 includes program code for modeling the accessed property data, according to a heuristic mathematical construct described herein, to produce corresponding results such as the determination of regression coefficients and other data, as appropriate for the subject property. Further, the regression module 209 is also configured to apply exclusion rules to and to calculate adjustment factors for the individual comparable properties. The regression module 203 may also calculate the economic distance and the weight the comparable property in reference to the subject property. For example, modeling may comprise carrying out the regression upon the accessed property data and weighting the accessed property data based upon each individual property data point's appropriateness for the subject property. Further, weighting the accessed property data may be based upon a set of factors computed from explanatory variables extracted from the property data and corresponding photographic appraisal information. For instance, once the property data (e.g. comparable properties) is accessed by the property data access module 206, the regression module 209 performs a regression to model the relationship between price and explanatory variables.

The following hedonic regression is one example of a possible hedonic model, and an ordinarily skilled artisan will readily recognize that various different variables may be used in conjunction with the present invention. In general, a hedonic regression is performed at a geographic level (e.g., county, census tract, etc.) sufficient to produce reliable results. In modeling the accessed property data using a hedonic equation, the dependent variable is a sale price and the explanatory variables may include the physical characteristics, such as gross living area, lot size, age, number of bedrooms, and number of bathrooms, as well as location specific effects, time of sale specific effects, property condition effect (or a proxy thereof). In this particular example, the dependent variable is the logged sale price. The explanatory variables are (1) four continuous property characteristics: (a) log of gross living area (GLA), (b) log of Lot Size, (c) log of Age, and (d) Number of Bathrooms; and (2) three fixed effect variables: (a) location fixed effect (e.g., by Census Block Group (CBG)), (b) Time fixed effect (e.g., measured by 3-month periods (quarters) counting back from the estimation date), and (c) Foreclosure status fixed effect, which captures the maintenance condition and possible REO discount. The exemplary equation (Eq. 1) is as follows:

$$ln ( p ) = {β}_{gla} \cdot ln ( GLA ) + {β}_{lot} \cdot ln ( LOT ) + {β}_{age} \cdot ln ( AGE ) + {β}_{bath} \cdot BATH ++ {\sum }_{i = 1}^{{N}_{CBG}} {LOC}_{i}^{CBG} + {\sum }_{j = 1}^{{N}_{QTR}} {TIME}_{j} + {\sum }_{k = \{ 0 , 1 \}}^{ } {FCL}_{k} + ɛ \qquad ( Eq . 1 )$$

Therefore, using the hedonic regression, a pool of comparable properties is identified, such as by initial exclusion rules based upon characteristic similarities and other factors in relation to a subject property. That is, the hedonic regression uses comparable selection rules to narrow the pool of comparable properties in excluding the properties that are determined to be insufficiently similar to the subject.

A set of adjustments for each comparable is determined using adjustment factors drawn from the regression analysis. These adjustments are then used by the regression module 209 to derive an economic distance between each comparable and the subject property. For example, the economic distance may be a value indicative of the estimated price difference between a comparable property and the subject that is determined from the set of adjustments for that comparable property. The comparables are then weighted according to the economic distance, physical distance, and time (of sale) between the comparable and the subject property.

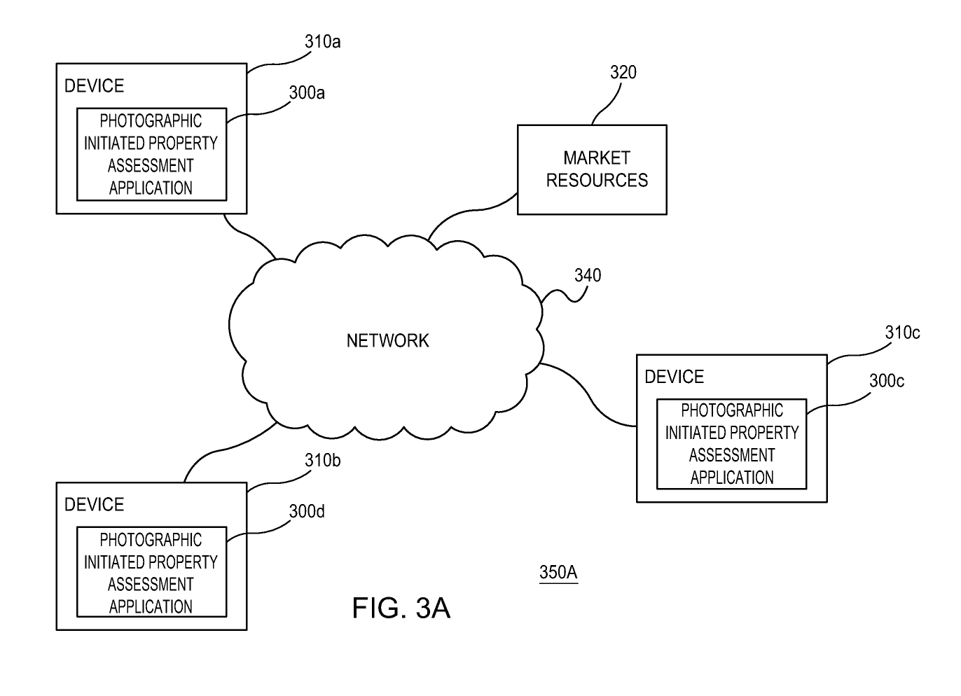

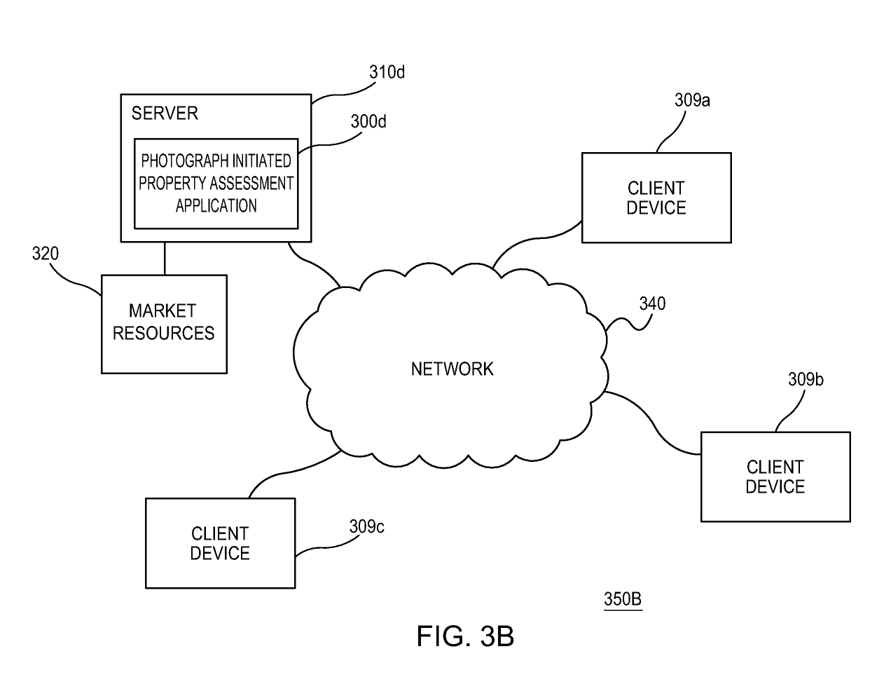

FIGS. 3A-B are block diagrams illustrating examples of a system in which a photograph initiated property assessment application operates. Specifically, FIG. 3A is block diagram illustrating an example of a system 350A in which the photograph initiated property assessment applications 300a-c operate. FIG. 3A further illustrates several devices 310a-c, each having the photograph initiated property assessment applications 300a-c installed thereon (see also FIG. 2A-B). The devices 310a-c are preferably tablet computers, but may alternatively be any of the computer systems described above. The network 340 over which the devices 310a-c (through their interfaces, which are not shown) communicate is preferably a cellular network; however, it may alternatively be any conventional networking technology. For instance, the network may be any of the technologies of cellular network, global area network, wireless local area networks, wide area networks, local area networks, or combinations thereof, but is not limited thereto. Further, the interfaces of the devices 310a-c may be any interface suited for input and output of communication data, whether that communication is visual, auditory, electrical, transitive, or the like.

FIG. 3B is an alternative where client devices 309a-c may respectively access a device 310d (see also FIG. 2A-B), preferably through direct application linking, with the device 310d providing the photograph initiated property assessment application 300d for access by the client devices 309a-c. In this embodiment, the device 310d is preferably a server providing application access to and computing power for use by client devices 309a-c (i.e. tablets with ‘client’ versions of the comparable properties analysis application not installed thereon). For example, the user devices 309a-c may be configured with a web browser application, with the photograph initiated property assessment application 300d configured to run in the context of the operability of the browser application. This configuration may also implement a network architecture wherein the user devices 309a-c provide, share, and rely upon the photograph initiated property assessment application 300d operability. This would reduce the resource requirements on the client devices and enhance efficiency of the system 350B. However, as another alternative, the operability of the photograph initiated property assessment application 300d may be divided between the client devices 309a-c and the server 310d, where the functions may be located separately on any device and accessed through distributed computing, such that the operability is provided for, shared, and relied upon by other devices. Finally, of course, a single computing device may be independently configured to include the entire operability of the photograph initiated property assessment application 300d.

Additionally, as illustrated in FIGS. 3A-B, market resources 320 are shown as a singular block in the figure, but it should be understood that the singular block represents a variety of resources, including financial intuition databases, MLS listings, GIS data, or resources compiled by an information services provider (e.g. tax assessors, other appraising services, and the like). Further, market resources 320 are typically accessed externally for use by the applications 300a-d (and their respective property data access modules 201), since the amount of property data is rather voluminous, and since the application is configured to allow access to multiple loan databases and multiple auto resource databases. The applications 300a-d access and retrieve the market data from these resources in support of photograph initiated property assessment.

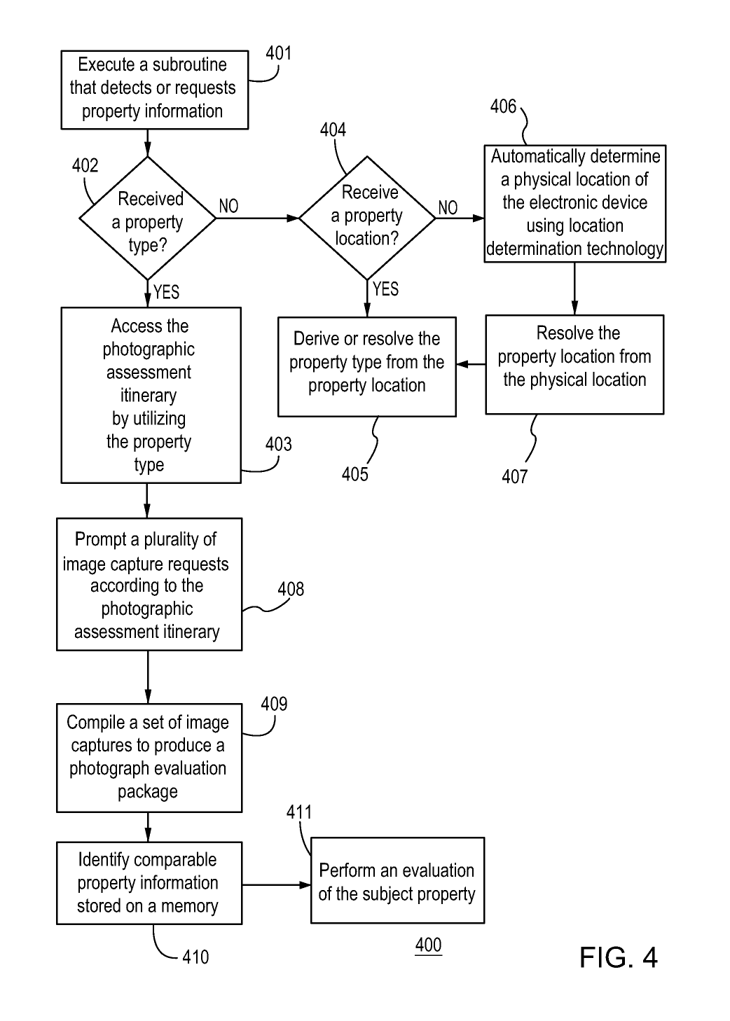

FIG. 4 is a flow diagram illustrating another example of a photograph initiated property assessment process 400. This example of a photograph initiated property assessment process 400 is an operational narrative of the photograph initiated property assessment application 200A where a user employs a tablet PC while on location at a prospect property (the subject property).

Thus, after the user turns the tablet PC on, an input is received that indicates the selection of an icon that opens the application 200A. Upon opening, the application 200A prompts a user, through a pop-up or other means, to indicate whether the user wants to initiate a photographic assessment itinerary for a subject property. At this point the user may request to generate a photographic assessment itinerary or manage a previous assessment. When the photographic assessment itinerary is requested, the application 200A executes 401 a subroutine that detects or requests a property type input, which is received and evaluated to access 408 the corresponding photographic assessment itinerary.

That is, when executing 401 a subroutine the application 200A may receive, generate, or retrieve property type information or property location information for the subject property. In one example, if the application receives 402 a property type that the user manually inputted, the application 200A may directly utilize the user inputted property type to access 403 a photographic assessment itinerary. If the application receives 404 a property location (e.g. an address) from the user, then the application 200A derives 405 the property type from the address via a database analysis. That is, the application 200A may use a locally stored database or table (or connect to an external service) to correlate the user inputted address with a property type. Alternatively, if the user request to generate the photographic assessment itinerary without entering any additional data, the application may derive the property type through an automatic determination 406 of a physical location of the tablet PC by the location determination technology described above, resolve 407 the physical location with an address table or database to identify an address using the access technology described above, and resolve 405 the identified address with a property type table or database to identify a property type. Specifically, the physical location and digital signature (GPS coordinates) of the tablet PC are automatically correlated with at least one individual postal address from an address database, which may be stored on the tablet PC. Once the at least one individual postal address is acquired, the application 200A performs a confirmation operation to confirm that the correct address was chosen for the GPA coordinates. One example of a confirmation operation is to prompt the user with the at least one individual postal address. If multiple addresses correlate to the GPS coordinates, than multiple addresses may be displayed. After user review of the automatic address suggestions, the user may via the display module 204 select one of the suggested addresses or choose to input a custom address. Based on the user's instruction, the application 200A may associate a postal address with the GPS coordinates and determine the property type.

Regardless of how the property type is received and providing the property type is correctly identified, the application accesses 403 the photographic assessment itinerary using the property type, where accessing the photographic assessment itinerary includes requesting an internal circuit to generate the photographic assessment itinerary, requesting an external device circuit to generate the photographic assessment itinerary, or retrieving a previously generated photographic assessment itinerary from memory local to the tablet PC or from an external device (e.g. market resources 320).

To generate the photographic assessment itinerary, the application 200A uses a heuristic algorithm that generates common photographic sequences (or generic itineraries) to generic property types. The application may also generate a unique set of target portions that are defined according to a specific subject property. While common photographic sequences take advantage of the similar characteristics across similar property types, unique target sets accommodate custom built homes. Thus, for instance, because a single family property type has different characteristics from a movable dwelling property type, the application may not reuse a single family itinerary for a mobile home itinerary and may reuse a single family itinerary for another generic single family property. Further, because common photographic sequences are specific to particular property types, the application 200A supports the algorithm with a comprehensive selection of photographic itineraries that applies to an array of properties. One example of a property type list is (example 1) single family, multi-family, attached multi-unit housing, and semi-detached dwellings. Another example of a property type list may be mansion, villa, farm house, colonial house, row house, duplex, single detached, and bungalow. Another example of a property type list may be a condo, a duplex, a townhome, a single family, and a multi-family. Regardless of nomenclature or number of property types, the list of property types may be arrange, divided, and subdivided in any manner suited for generating the most appropriate housing type and the heuristic algorithm expands and subdivides the property type list as it receives and generates more data. One example of subdividing is when a user selects the single family property type from the property list in example 1; in response, the heuristic algorithm presents a sub-list to further define the subject property. For example, a sub-list for the single family property type may be cottage, rancher, suburban home, and urban manor. Thus, the application 200A using the heuristic model may build a property type tree to parse or direct subject property type identification. In the current operational example, the user manually inputted a single family property type, which the application 200A identified by executing 401 the subroutine that receives and evaluates the user's manual input. Therefore, the application 200A generates the photographic assessment itinerary using the single family property type.

To generate the photographic assessment itinerary, the application 200A, in the current operational example, generates the sequence of pictures according to appraisal form. If an appraisal form is not available, the application 200A may generate the photographic assessment itinerary using any subject property information document or utilized different property forms to support the generation of different photographic assessment itineraries. For example, a major photographic grouping of the itinerary may be generated and correlated to each section of an appraisal form, such that a first, a second, a third, a fourth, and a fifth major photographic grouping are generated according to the ‘subject,’ ‘neighborhood,’ ‘site,’ ‘improvements,’ and ‘comments’ section of the appraisal form. Further, under each major photographic grouping the set of prompts are then subdivided into minor photographic groupings that equal the number of categories within the sections of the appraisal form. That is, under the section of ‘improvements,’ the appraisal form categories are ‘general,’ ‘foundation,’ ‘exterior,’ and ‘interior.’ Furthermore, under each minor photographic grouping, prompts are generated and assigned to each field listed in the category. That is, in the ‘exterior’ category of the appraisal form, the fields are ‘foundation,’ ‘exterior walls,’ ‘roof surface,’ ‘gutters and downspouts,’ ‘window type,’ ‘storm sash/insulated,’ and ‘screens.’ In addition, the prompts that are assigned to these fields may be associated with at least one description tag. There are at least two description tags for the fields of the ‘exterior’ category, including a materials description tag and conditions description tag that are used for an additional information drop down menu. Similarly to the above described prompt assignment, the application generates and assigns prompts to the fields of the categories within each appraisal form section, while associating description tags with the prompts, to generate the photographic assessment itinerary. In other words, the prompt assignment process of generating major photographic groupings, minor photographic groupings, prompts, and additional information drop down menus is respectively repeated for every section, category, field, and description tag listed on the appraisal. Further, major and minor groupings and their respective categories, fields, and description tags are customizable, such that if it does not make sense to associate a prompt with a field (or a description tag with a prompt or the like) then that field is not associated with a prompt. For example, the field of the appraisal form may be customized into a set of sub-targets, such as sub-targets of a kitchen field may include room angle, window views, and fixtures when the kitchen field is the present field to be captured.

Accordingly, once the application 200A generates the photographic assessment itinerary using the single family property type, the application 200A utilizes the photographic assessment itinerary to prompt 408 a plurality of image capture requests according to the photographic assessment itinerary so that the user may begin the assessment of the subject property. The application 200A, based on the first prompt of the first major photographic grouping prompts the user to acquire a photograph. For instance, the first major photographic grouping is associated with the ‘subject’ section and is an instruction to the user to photograph the house from a street view perspective, where the resulting first photograph is associated with the first major photographic grouping as the cover photo. The second prompt is an instruction to photograph the house numbers, where the resulting second photograph is associated with the address line of the first major grouping. In this case, the ‘subject’ section has a field set that is relatively smaller in comparison to the other major photograph groupings. Therefore, because only two prompts were assigned to the first major grouping, the application 200A prompts that the second major grouping of the photographic assessment itinerary and a related set of photographic instruction according to the second major grouping have initiated.

As the application 200A progresses through the photographic assessment itinerary by prompting image captures of the relative fields and sections, the application 200A may also display a menu in synchronization with each prompt that allows additional information, such as descriptions tags, to be associated with captured images. For instance, once the user has successfully progressed to the second field (roof surface) of the third category (exterior) of the fourth major photograph grouping (improvements) and has taken a photograph of the roof of the subject property, the application 200A may display a first drop down menu (i.e. the materials description tag) that permits the selection of a roof material and a second drop down menu (i.e. the conditions description tag) that permits the selection of roof condition. The options in the first drop down menu may be slate, wood, metal, tile, and composite. The options in the second drop down menu may be poor, normal, and new. At the conclusion of the photograph initiated property assessment, the application compiles 409 the set of image captures to produce a photograph evaluation package. Thus, when an evaluator reviews the photograph evaluation package to evaluate the subject property, they may confirm that the condition and material descriptors selected by the user match the photograph that correlates to the filed (i.e. that the picture of the roof surface equates to the associated description tags).

Further, once the photograph evaluation package is complete, it may be used as a search and retrieval tool to identify 410 comparable property information stored on a memory of the tablet PC and display the appraisal information in a usable manner through the display module 204. The appraisal information should include a comparable properties list where each comparable property was determined to be appropriate for the subject property by the regression module 207. The appraisal information along with the photograph evaluation package is used by the application 200A to perform 411 an evaluation of the subject property, which is a price estimation. The application then presents a user interface that permits user operations of the application features and manipulation of the subject property evaluation.

Further, the operational example above may also be implemented in connection with a desktop computer that employs the application 200B to utilize a remote user device to assess a prospect property (the subject property). Thus, after the desktop computer initially opens the application 200B, the desktop computer establishes a connection with the user device. Alternatively, the application 200B may request and retrieve photographic assessment itinerary and appraisal information related to the identified subject property from local memory or other desktop terminals, as the request and retrieval operation is not limited to external market resources 320. For instance, accessing the photographic assessment itinerary may include requesting, by the desktop, an external resource to generate the photographic assessment itinerary and the desktop receiving the photographic assessment itinerary from the external source. Further, either application 200A or B may use a hybrid of generating and retrieving the photographic assessment itinerary and appraisal information. Furthermore, regardless of the source, the appraisal information should include a comparable properties list and when appropriate, the comparable properties list may indicate which comparable properties were chosen by the application (as in chosen locally on the tablet PC or desktop computer using local resources) or by the regression model (as in selected externally to the application using external resources). That is, when the application 200A generates property information locally and independent of external sources, the list should clearly indicate that the comparable properties were selected by the application's 200A regression module 204 (app-chosen), and when the external market resources 320 and the models that govern those resources provided the property information, the list should clearly indicate that the comparable properties were selected by the regression models of those resources (model chosen).

Embodiments of the described produce and provide methods and apparatus for a model for providing real-time location-based promotions to a vehicle purchaser without the need for additional post-purchase decision conversations and signing ceremonies. Although the described is detailed considerably above with reference to certain embodiments thereof, the invention may be variously embodied without departing from the spirit or scope of the invention. Therefore, the following claims should not be limited to the description of the embodiments contained herein in any way.

What is claimed is:

1. A method for producing a photograph initiated property assessment, comprising:
receiving a request for a photographic assessment itinerary for a subject property;
accessing the photographic assessment itinerary, the photographic assessment itinerary being generated in response to the request, the photographic assessment itinerary including a plurality of target portions for the subject property and a set of image capture requirements for each of the plurality of target portions;
prompting a plurality of image capture requests according to the photographic assessment itinerary; and
displaying a menu that allows additional information to be associated with captured images in association with the prompting of the plurality of image capture requests.

2. The method of claim 1, wherein the plurality of target portions is defined according to property type.

3. The method of claim 2, wherein the property type is selected from a set of properties types including a condo, a duplex, a townhome, a single family, and a multi-family.

4. The method of claim 1, wherein the plurality of targets portions is generic parts of a selected property type.

5. The method of claim 4, wherein the each target of the set of targets is further divided into a set of sub-targets including room angle, views, and fixtures.

6. The method of claim 1, wherein accessing the photographic assessment itinerary includes requesting an external resource to generate the photographic assessment itinerary and receiving the photographic assessment itinerary from the external source.

7. The method of claim 1, wherein accessing the photographic assessment itinerary includes requesting an internal circuit to generate the photographic assessment itinerary.

8. The method of claim 1, further comprises compiling the set of image captures in preparation to produce a photograph initiated property assessment.

9-16. (canceled)

17. A computer program product stored on a non-transitory computer readable medium including a set of computer-executable instructions, the instructions comprising instructions for:
receiving a request for a photographic assessment itinerary for a subject property;
accessing the photographic assessment itinerary, the photographic assessment itinerary being generated in response to the request, the photographic assessment itinerary including a plurality of target portions for the subject property and a set of image capture requirements for each of the plurality of target portions;
prompting a plurality of image capture requests according to the photographic assessment itinerary; and
displaying a menu that allows additional information to be associated with captured images in association with the prompting of the plurality of image capture requests.

18. The computer program product according to claim 9, wherein the plurality of target portions is defined according to property type.

19. The computer program product according to claim 10, wherein the property type is selected from a set of properties types including a condo, a duplex, a townhome, a single family, and a multi-family.

20. The computer program product according to claim 9, wherein the plurality of targets portions is generic parts of a selected property type.

21. The computer program product according to claim 12, wherein the each target of the set of targets is further divided into a set of sub-targets including room angle, views, and fixtures.

22. The computer program product according to claim 9, wherein accessing the photographic assessment itinerary includes requesting an external resource to generate the photographic assessment itinerary and receiving the photographic assessment itinerary from the external source.

23. The computer program product according to claim 9, wherein accessing the photographic assessment itinerary includes requesting an internal circuit to generate the photographic assessment itinerary.

24. The computer program product according to claim 9, further comprising:
compiling the set of image captures in preparation to produce a photograph initiated property assessment.
